(19) United States
(12) Patent Application Publication
(10) Pub. No.: US 2018/0154548 A1
(43) Pub. Date: Jun. 7, 2018

(54) MOLD FOR MANUFACTURING SELF-LOCKING BLOCKS MADE OF CEMENT MATERIAL

(71) Applicant: BRUNELLO MARCO S.R.L., San Dona' Di Piave (IT)

(72) Inventor: Marcantonio BRUNELLO, San Dona' Di Piave (IT)

(21) Appl. No.: 15/579,863

(22) PCT Filed: Dec. 29, 2015
(86) PCT No.: PCT/EP2015/081370

§ 371 Date: Dec. 5, 2017

(30) Foreign Application Priority Data
Jun. 10, 2015 (IT) 102015000022126

(51) Int. Cl. B28B 1/08; B28B 1/087; B28B 7/00; B28B 7/20; B28B 7/24

(52) U.S. Cl. CPC B28B 1/081; B28B 1/0873; B28B 7/24; B28B 7/20; B28B 7/0097

(57) ABSTRACT

A mold for manufacturing self-locking blocks made of cement material, includes a mold box, provided with a rigid external frame, with a rigid insert which has internal cavities for obtaining the blocks. The mold further includes a presser shaped complementarily to the insert, and a flexible connecting joint being present perimetrically between the frame and the insert. The insert rests on a table which interacts with a vibrating surface.

### TECHNICAL FIELD

The present disclosure relates to a mold for manufacturing self-locking blocks made of cement material.

### BACKGROUND

Nowadays the use is known of a mold for manufacturing self-locking blocks made of cement material, which is composed of a lower part, called a mold box or female mold part, and of an upper part, called a presser or male mold part.

The conventional type of mold box has an external steel frame for anchoring it to the pressing machine, and a tempered steel insert which has internal cavities for obtaining the blocks.

The frame and the insert are rigidly connected to each other by way of welds and/or by way of fixing with screws and/or bolts.

In order to manufacture self-locking blocks made of cement material, nowadays it is known to mount the mold on a press, resting the mold box on a table made of wood or steel, which in turn rests on a vibrating surface; the insert is then filled with cement material by way of a feeder.

Subsequently, once the cement material has been deposited in the internal cavities of the insert, a first vibration step begins of the mold box alone for a first compaction, while the presser is in the raised position, followed by the lowering of the presser and by the subsequent compression of the mold box at the same time as a second vibration step of the mold box, so as to obtain the complete compacting of the cement material.

Once the cement material has been suitably pressed and vibrated, the mold box is automatically lifted in order to allow the blocks to exit the respective cavities and be left on the table.

Finally, the tables with the blocks, by way of conveyor belts, are sent to the curing cells.

A drawback that has been found in the known art consists of the presence of a rigid connection between the frame and the insert, by way of welds and/or by way of fixing with screws and/or bolts, which entails the transmission of the vibrations for compaction of the material to the frame carrying the insert, creating considerable dispersions of vibration.

A further drawback caused by the propagation of the vibrations to the frame is constituted by the formation of cracks, fissures and breakages of the welds or of the screws and of the bolts, as well as the breakage of the rigid means used to keep the frame as motionless as possible during the vibration steps.

Furthermore the transmission of the vibrations to the frame entails an increase in the noise level of the machine, as well as a resonance produced by the vibrations proper.

### SUMMARY

The aim of the present disclosure is to eliminate the above mentioned drawbacks by providing a mold for manufacturing self-locking blocks made of cement material which is more efficient and which limits the dispersion of the vibrations, while increasing, for the same vibration time imposed by the vibrating surface, the quality of compaction of the cement material.

Within this aim the present disclosure provides a mold with low noise and which prevents the vibrations produced from resonating.

The disclosure further provides a mold that is structurally simple and low cost and can be made with the usual conventional plants.

This aim and these and other advantages which will become better apparent hereinafter are achieved by providing a mold for manufacturing self-locking blocks made of cement material, which comprises a mold box, provided with a rigid external frame, with a rigid insert which has a plurality of internal cavities for obtaining said blocks, and a presser which is shaped complementarily to said insert, characterized in that a flexible connecting joint is present perimetrically between said frame and said insert, said insert resting on a table which interacts with a vibrating surface.

### BRIEF DESCRIPTION OF THE DRAWINGS

Further characteristics and advantages of the disclosure will become better apparent from the detailed description of a particular, but not exclusive, embodiment, which is illustrated by way of non-limiting example in the accompanying drawings wherein:

FIG. 1 is a perspective view from above of a mold for manufacturing self-locking blocks made of cement material;

FIG. 2 is a perspective view from above of the mold box of the mold;

FIG. 3 is a view from above of the mold box of the mold;

FIG. 4 is an exploded view of the mold box of the mold; and

FIG. 5 is a cross-sectional view of a detail of the disclosure.

### DETAILED DESCRIPTION OF THE DRAWINGS

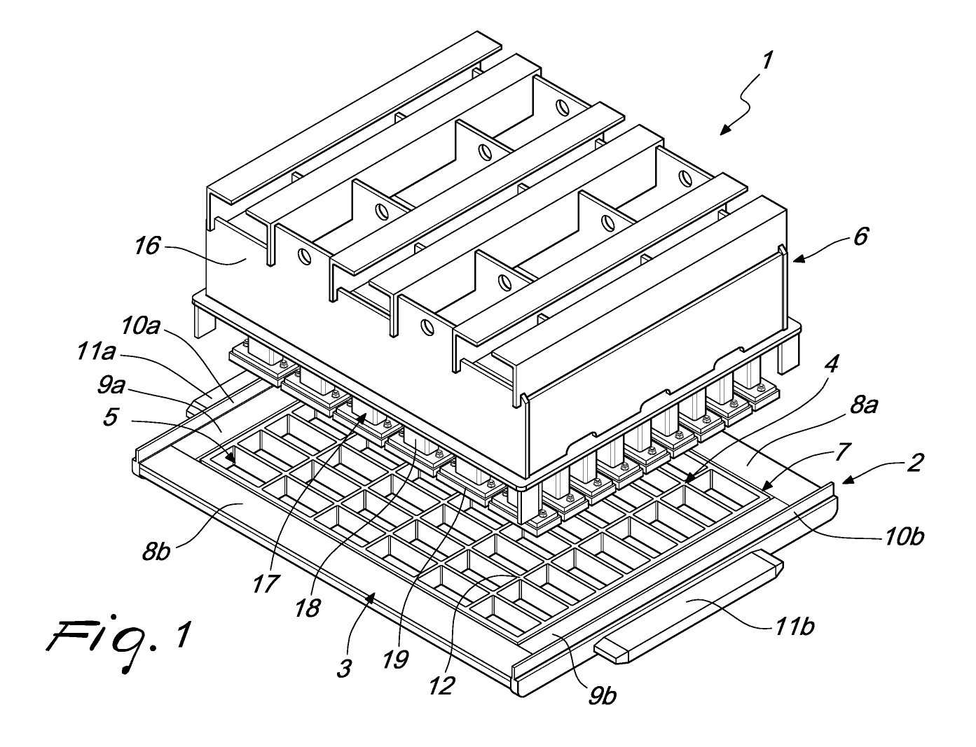

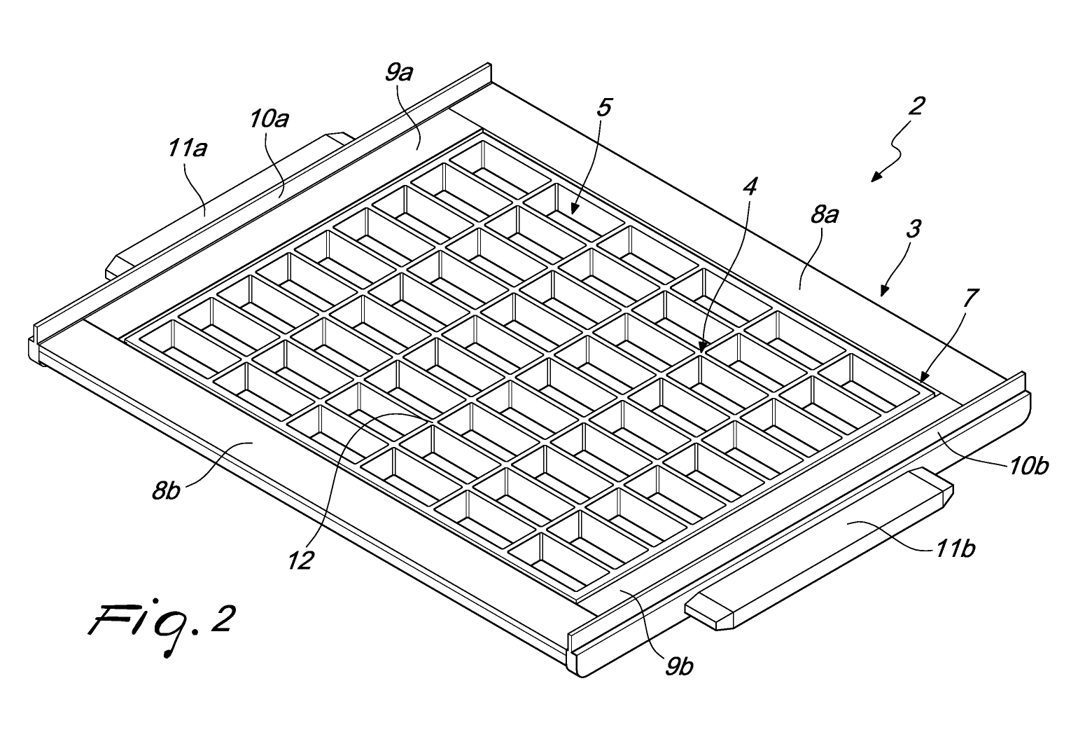

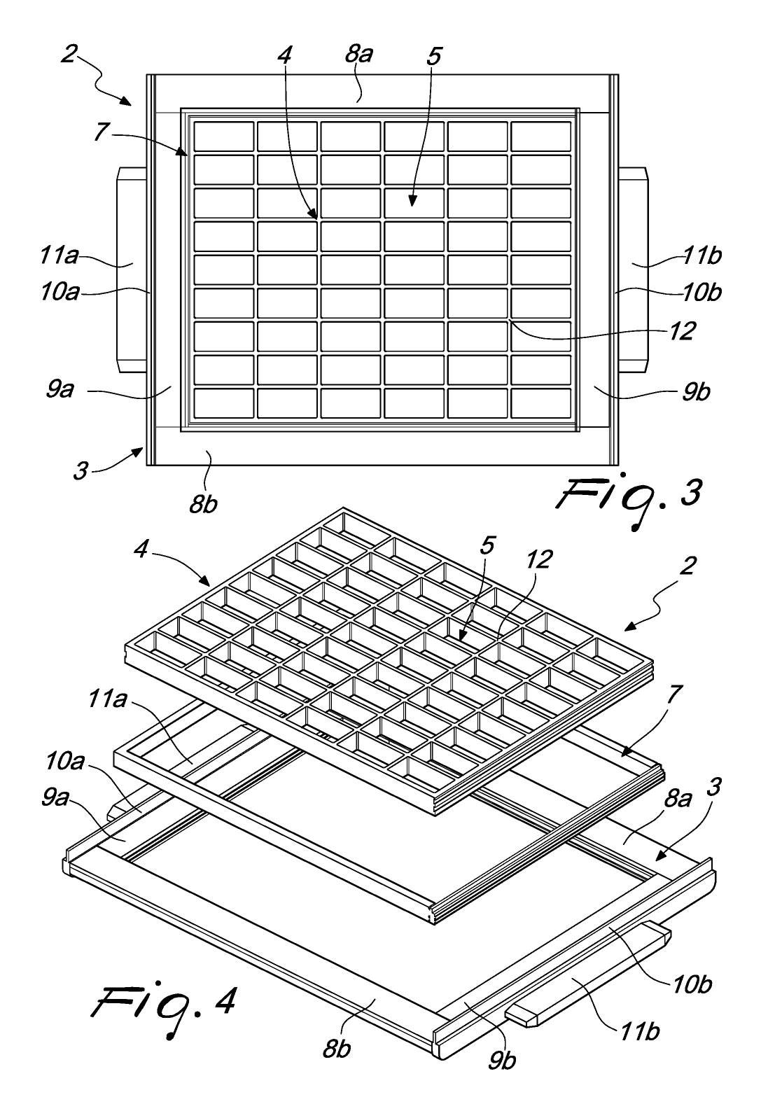

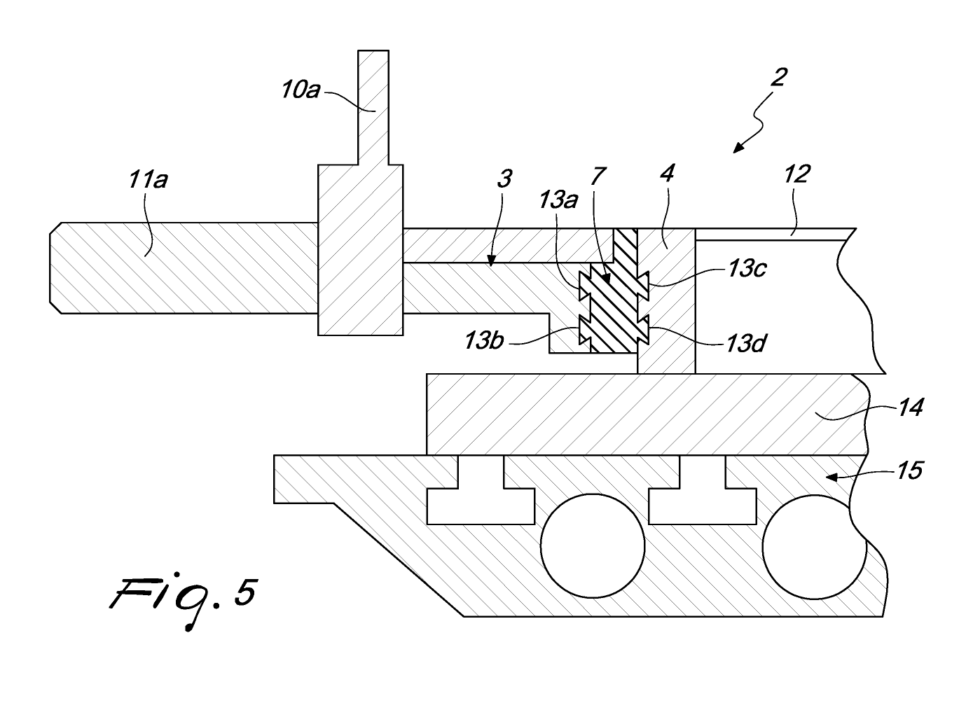

In the embodiments illustrated in FIGS. 1-5, individual characteristics shown in relation to specific examples may in reality be interchanged with other, different characteristics, existing in other embodiments.

With reference to the figures, the reference numeral 1 generally designates a mold for manufacturing self-locking blocks made of cement material which comprises in a downward region a substantially rectangular mold box 2, which is provided with a rigid external frame 3 and with a rigid internal insert 4 which has a plurality of mutually identical internal cavities 5 which are shaped so as to obtain the blocks; the mold box 2 further comprises a flexible connecting joint 7 which is arranged perimetrically between the frame 3 and the insert 4.

A presser 6 shaped complementarily to the insert 4 and arranged above it contributes to defining the mold 1.

The frame 3, preferably made of steel, constitutes the external perimetric part of the mold box 2, is rectangular in shape, is internally hollow, and is constituted by two longitudinal members 8a, 8b and by two cross-members 9a, 9b.

Two centering elements 10a, 10b are stably and rigidly connected on the lateral surfaces of the members 8a, 8b, and are shaped like an inverted T and are asymmetric, with the larger wing directed away from the insert 4.

Two rectangular handles 11a, 11b are rigidly and stably connected externally to the two centering elements 10a, 10b and act as a grip for a pair of jaws, the function of which is to keep the frame 3 in a static position and in equilibrium.

The insert 4, preferably made of tempered steel, constitutes the internal part of the mold box 2 and is substantially rectangular and is shorter and narrower than the two longitudinal members 8a, 8b and than the two cross-members 9a, 9b of the frame 3, and is higher or thicker than the frame 3.

The insert 4 is provided internally with a grid 12 made of tempered steel which defines the rectangular internal cavities 5, which have a thickness equal to that of the insert 4.

The flexible joint 7 is arranged perimetrically between the frame 3 and the insert 4, is rectangular and is shorter and narrower than the two longitudinal members 8a, 8b and than the two cross-members 9a, 9b of the frame 3 and is longer and wider than the insert 4 and has a height or thickness substantially equal to that of the frame 3, and therefore lower or thinner than that of the insert 4.

The flexible joint 7 stably connects the frame 3 with the insert 4 by way of coupling elements, such as dovetail joints 13a, 13b, 13c, 13d, or by way of adhesives.

Furthermore the joint 7 is preferably made of rubber or plastic material and can optionally be cast between the frame 3 and the insert 4.

During the production of the self-locking blocks made of cement material, only the insert 4 rests on a table 14, made of wood or steel, interacting with a vibrating surface 15, it being the thickest component out of all the components of the mold box 2.

The presser 6 is constituted by a main body 16 which is substantially parallelepiped in shape, on the lower surface of which pistons 17 are provided which protrude below at the internal cavities 5 of the insert 4.

The pistons 17 are substantially T-shaped, the shank 18 of the T being rigidly and stably connected to the lower surface of the presser 6, and the head 19 of the T having the same dimensions as each of the internal cavities 5, so that there is a movable connection between the cement material that fills the internal cavities 5 and the head 19 of the pistons 17 during the step of compression and simultaneous vibration.

Thus it has been found that the disclosure fully achieves the intended advantages, by providing a mold for manufacturing self-locking blocks made of cement material in which the use of the flexible joint 7, arranged perimetrically between the frame 3 and the insert 4, considerably reduces the vibrations to the frame 3, thus eliminating the risk of formation of cracks, fissures and breakages to the frame 3 and to the jaws, which are used to keep the frame 3 in equilibrium and in a static position.

Furthermore, a greater concentration of the vibrations on the insert 4 has been obtained, with the consequent increase, for the same vibration time imposed by the vibrating surface, in the quality of compaction of the cement material and in the strength of the final product.

It has also been observed that the reduction of the transmission of the vibrations to the frame 3 entails a decrease in the noise level of the machine and in the resonance produced by the vibrations proper, thus making the disclosure quieter.

Finally, an increase has been obtained in the production cycles owing to the lack of welds or other traditional rigid connections between the frame 3 and the insert 4, and a saving of maintenance costs has been obtained, the rigid connections having been eliminated.

The disclosure is susceptible of numerous modifications and variations. Obviously the materials used as well as the dimensions of the individual components of the disclosure may be more relevant according to specific requirements.

The characteristics indicated above as advantageous, convenient or the like, may also be missing or be substituted by equivalent characteristics.

The disclosures in Italian Patent Application No. 102015000022126 from which this application claims priority are incorporated herein by reference.

1-6. (canceled)

7. A mold for manufacturing self-locking blocks made of cement material, the mold comprises a mold box, provided with a rigid external frame, with a rigid insert which has a plurality of internal cavities for obtaining said self-locking blocks, and a presser shaped complementarily to said insert, wherein a flexible connecting joint is present perimetrically between said frame and said insert, and said insert rests on a table which interacts with a vibrating surface.

8. The mold for manufacturing self-locking blocks made of cement material according to claim 7, wherein said insert is substantially rectangular and shorter and narrower than two longitudinal members and two cross-members which constitute said frame, said insert being higher or thicker than said frame, wherein only said insert rests on said table.

9. The mold according to claim 8, wherein said flexible connecting joint, arranged perimetrically between said frame and said insert, is rectangular and shorter and narrower than said two longitudinal members and said two cross-members of said frame and longer and wider than said insert, having a height or thickness substantially equal to that of said frame and being lower or thinner than that of said insert.

10. The mold according to claim 7, wherein said flexible connecting joint stably connects said frame with said insert by way of coupling elements, such as dovetail joints, or by way of adhesives.

11. The mold according to claim 7, wherein said flexible connecting joint, said insert and said frame are provided in a single piece.

12. The mold according to claim 7, wherein said flexible connecting joint is made of rubber or plastic material.
